(19) United States
(12) Patent Application Publication
(10) Pub. No.: US 2002/0085160 A1
(43) Pub. Date: Jul. 4, 2002

(54) Liquid crystal panel for liquid crystal display device and fabricating method for the same

(76) Inventors: Young-Hun Ha, Gyeongsangbuk-do (KR); Jae-Moon So, Gyeongsangbuk-do (KR); Jong-Woo Kim, Gyeongsangbuk-do (KR)

Correspondence Address: SONG K. JUNG, LONG ALDRIDGE & NORMAN LLP, Suite 600, 701 Pennsylvania Avenue, N.W., Washington, DC, 20004, US

(21) Appl. No.: 10/028,289

(22) Filed: Dec. 28, 2001

(30) Foreign Application Priority Data
Dec. 29, 2000 (KR) 2000-85421

(51) Int. Cl. G02F 1/1339

(52) U.S. Cl. 349/153

(57) ABSTRACT

A liquid crystal panel that includes an array substrate fabricated using four mask process, wherein a passivation layer in a seal pattern forming region between a display area and a non-display area is removed during a photolithography mask step for simultaneous patterning an active layer and a passivation layer to maintain a cell gap

This application claims the benefit of Korean Patent Application No. 2000-85421, filed on Dec. 29, 2000 in Korea, which is hereby incorporated by reference as if fully set forth herein.

### BACKGROUND OF THE INVENTION

1. Field of the Invention

The present invention relates to a liquid crystal display (LCD) device, and more particularly, to a liquid crystal panel for liquid crystal display devices and a method of fabricating the same, which uses a four mask process for fabricating an array substrate of the liquid crystal panel.

2. Discussion of the Related Art

Generally, liquid crystal display devices make use of an optical anisotropy and the polarization properties of the liquid crystal to display images. Because a shape of a liquid crystal molecule is long and thin, liquid crystal molecules have an alignment direction. The alignment direction of the liquid crystal molecules can be controlled by applying an electric field to the liquid crystal. Accordingly, if the alignment direction of the liquid crystal molecules is controlled according to the applied electric field, incident light is refracted according to the alignment of the liquid crystal molecules to display images. Presently, active matrix LCD (AM LCD) devices are one of the most popular means for displaying images because of their high resolution and superiority in displaying moving images.

In FIG. 1, a liquid crystal panel includes an upper substrate 12, referred to as a color filter substrate, and a lower substrate 14, referred to as an array substrate, and an interposed liquid crystal layer 16 between the upper substrate 12 and the lower substrate 14. The upper substrate 12 and the lower substrate 14 are spaced apart from each other and face each other. A gate electrode 18 is formed on a transparent substrate 1 of the lower substrate 14 and a gate insulating layer 20 is formed on the substrate 1 and covers the gate electrode 18. A semi-conductor layer 22 that includes an active layer 22a and an ohmic contact layer 22b is formed on the gate insulating layer 20. A source electrode 26 and a drain electrode 24 are formed on the semi-conductor layer 22. A passivation layer 28 that includes a source contact hole 30 is formed on the source and drain electrodes 26 and 24. A pixel electrode 32 that contacts the source electrode 26 through the source contact hole 30 and functions as one of electrodes to apply a voltage to the liquid crystal 16, is formed on a passivation layer 28. A thin film transistor “T” includes the gate electrode 18, semi-conductor layer 22 and the source and drain electrodes 26 and 24.

A black matrix 34 is formed beneath a transparent substrate 1 of the upper substrate 12 corresponding to the thin film transistor “T”. A color filter 36 is formed beneath the transparent substrate 1 of the upper substrate 12 corresponding to the pixel electrode 32. A flat layer 38 is formed beneath the black matrix 34 and the color filter 36. A common electrode 40 that functions as another electrode to apply a voltage to the liquid crystal is formed beneath the flat layer 38. A spacer 42 that maintains a cell gap uniformly between the upper substrate 12 and the lower substrate 14 is disposed between the pixel electrode 32 and the common electrode 40. A seal pattern 44 that maintains the cell gap uniformly in addition to the spacer 42 is formed between the upper substrate 12 and the lower substrate 14. The lower substrate 14 is formed using a five mask process and includes a region where the seal pattern 44 is formed. The gate insulating layer 20 and the passivation layer 28 are formed on an entire area of the lower substrate 14. When comparing a distance d₁ of the cell gap maintained by the spacer 42 with a distance d₂ of the cell gap maintained by the seal pattern 44, because the pixel electrode 32 under the spacer 42 is formed very thin and thus does not affect a cell gap margin, the distances d₁ and d₂ can be maintained at almost the same distance.

The five mask process for fabricating the lower substrate 14 consists of following steps. A first mask step includes forming the gate electrode 18; a second mask step includes forming the semi-conductor layer 22; a third mask step includes forming the source and drain electrodes 26 and 24; a fourth mask step includes forming the source contact hole 30 through the passivation layer 28; and a fifth mask step includes forming the pixel electrode 32. Each of the mask steps is performed by introducing a photolithographic masking technique for patterning each layer. If the total number of mask steps is reduced, production time and production cost can be reduced and thereby the number of inferior goods can be decreased. The five mask process for fabricating the array substrate of the liquid crystal display devices has been widely used in the art, but four mask process has been adopted in the art recently.

FIG. 2 is a flow chart showing a fabricating process of an array substrate of liquid crystal display devices using a four mask process according to the related art. A first mask step ST1 includes forming a gate electrode, a capacitance electrode and a gate line. The gate line that includes the gate electrode and the capacitance electrode is formed by sputtering metal material on a transparent substrate and then etching the sputtered metal material. The etching process is performed using a photolithography masking technique and using a first mask. The metal material for the gate electrode is selected from a group consisting of aluminum (Al), aluminum alloys and a double metal layer including aluminum (Al).

A second mask step ST2 includes forming a channel, a source electrode and a drain electrode. On-off switching of a thin film transistor is performed in the channel. An ohmic contact layer, the source electrode, the drain electrode and a data line are formed using a second mask after forming gate insulating material, amorphous silicon (a-Si), doped amorphous silicon and metal on the substrate. The ohmic contact layer, which is formed by doping ions on the active layer to increase movement of electrons, serves to reduce a contact resistance between the active layer and the metal layer. The metal material for the source and drain electrodes is selected from a group consisting of molybdenum (Mo), chromium (Cr), tungsten (W) and nickel (Ni) which have a high corrosion-resistance and a high mechanical strength. The second mask step further includes forming of an auxiliary capacitance electrode using the metal material used for the data line.

A third mask step ST3 includes forming an active layer and a passivation layer. The active layer and the passivation layer are patterned simultaneously using a third mask in this process. The third mask step may further include forming a source contact hole depending on a structure of the array substrate. The patterning processes of the active layer and the passivation layer are simultaneously performed outside of the source and drain electrodes to prevent the patterning process from being delayed due to the formation of the source and drain electrodes. The passivation layer prevents the thin film transistor from damage caused by scratches and permeated moisture during a rubbing process or a subsequent delivery process. The passivation layer is formed using silicon nitride (SiNₓ) or benzocyclobutene (BCB).

A fourth mask step includes forming a pixel electrode. The pixel electrode is formed by sputtering a transparent conductive material on the substrate and patterning the sputtered transparent material using a fourth mask. Indium tin oxide (ITO) is usually selected for the transparent conductive material because it has a low contact resistance with a metal and provides a low resistance in a tab bonding process performed for connecting the pixel electrode to an external electric circuit. The pixel electrode may be connected to a lateral side of the thin film transistor or may be connected to an upper side of the source electrode through the source contact hole that is formed in the third mask step.

FIG. 3 is a cross-sectional view illustrating a part of a liquid crystal panel that includes an array substrate fabricated using a conventional four mask process. As shown in the figure, the liquid crystal panel 50 includes an upper substrate 52 and a lower substrate 54 that are spaced apart and facing each other. A spacer 56 and a seal pattern 58 that maintain a cell gap distance is uniformly disposed between the upper substrate 52 and the lower substrate 54. Liquid crystal 53 is injected into the cell gap between the upper substrate 52 and the lower substrate 54. As shown in the figure, there exists a cell gap difference in an amount of about the height of the passivation layer 60 between a cell gap distance d₃ in a pixel region “P” and a cell gap distance d₄ in a seal pattern forming region. The difference is caused by the active layer 61 and the passivation layer 60 undergoing a patterning process simultaneously using the third mask. The passivation layer in the pixel region is etched away during the third mask step. Whereas the pixel electrode 64 is formed directly on the gate insulating layer 62 in the pixel region “P”, the passivation layer 60 still remains on the gate insulating layer 62 in the seal pattern forming region. If there is a difference between the cell gap distance in the pixel region and the cell gap distance in the seal pattern forming region, the disparity of the cell gap distance causes inferior images to be displayed.

### SUMMARY OF THE INVENTION

Accordingly, the present invention is directed to a liquid crystal panel for liquid crystal display devices and a fabricating method for the liquid crystal panel for liquid crystal display devices that substantially obviates one or more of problems due to limitations and disadvantages of the related art.

An advantage of the present invention is to provide a liquid crystal panel that includes an array substrate fabricated using a four mask process, wherein a passivation layer in a seal pattern forming region is removed to maintain uniform cell gap distance.

Another advantage of the present invention is to provide a fabricating method for the liquid crystal panel for liquid crystal display devices.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal panel for liquid crystal display devices comprises a lower substrate including a seal pattern forming region between a display area and a non-display area of the lower substrate, wherein a passivation layer is removed; an upper substrate; a seal pattern formed in a boundary region between the display area and the non-display area of the lower substrate; and a liquid crystal layer between the upper substrate and the lower substrate. The lower substrate further includes a first substrate, the display area and the non-display area. The lower substrate further includes a gate electrode on the first substrate; a gate insulating layer on the first substrate and on the gate electrode; a thin film transistor on the gate insulating layer; a pixel electrode that is connected to the thin film transistor on the gate insulating layer and a passivation layer on the thin film transistor. The upper substrate includes a second substrate, a color filter and a common electrode. The passivation layer in the boundary region between the display area and the non-display area of the lower substrate is removed in a photolithographic mask step for patterning an active layer and the passivation layer. The liquid crystal panel of the present invention further comprises spacers between the upper substrate and the lower substrate.

In another aspect, a liquid crystal panel for liquid crystal display devices comprises a lower substrate including a first substrate; a gate electrode on the first substrate; a gate insulating layer on the first substrate and on the gate electrode; a thin film transistor on the gate insulating layer; a pixel electrode on the gate insulating layer, the pixel electrode being connected to the thin film transistor and a passivation layer on the thin film transistor, the lower substrate being divided into a display area and a non-display area and further including a seal pattern forming region between the display area and the non-display area of the lower substrate, wherein a passivation layer is removed; an upper substrate including a second substrate, a color filter and a common electrode; a seal pattern formed in a boundary region between the display area and the non-display area of the lower substrate; and a liquid crystal layer between the upper substrate and the lower substrate.

In another aspect, a fabricating method for a liquid crystal panel for liquid crystal display devices comprises forming a lower substrate wherein a passivation layer in a boundary region between a display area and a non-display area of the lower substrate is removed; forming an upper substrate including a second substrate, a color filter and a common electrode; forming spacers in the display area between the upper substrate and the lower substrate; forming a seal pattern in a boundary region between the display area and the non-display area of the lower substrate, the seal pattern contacting a gate insulating layer; assembling the upper substrate and the lower substrate; and injecting liquid crystal into an interior of the seal pattern. The forming process of the lower substrate further comprises of forming a gate electrode on a first substrate; forming a gate insulating layer on the first substrate and on the gate electrode; forming a thin film transistor on the gate insulating layer; forming a pixel electrode on the gate insulating layer, the pixel electrode being connected to the thin film transistor.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view illustrating a part of a liquid crystal panel for liquid crystal display devices that includes an array substrate fabricated using a conventional five mask process.

FIG. 2 is a flow chart showing a fabricating process of an array substrate of liquid crystal display devices using a four mask process according to the related art;

FIG. 3 is a cross-sectional view illustrating a part of a liquid crystal panel that includes an array substrate fabricated using a conventional four mask process;

FIG. 4A shows a plan view of a liquid crystal panel for liquid crystal display devices according to the present invention;

FIG. 4B is a cross-sectional view illustrating a part of a liquid crystal panel that includes an array substrate fabricated according to the present invention;

FIG. 5 is a plan view illustrating a part of an array substrate of liquid crystal display devices fabricated using a four mask process according to the present invention;

FIG. 6 is a cross-sectional view of a liquid crystal panel that includes the array substrate of FIG. 5 and illustrates cross-sections taken along III-III′, IV-IV′ and V-V′ of FIG. 5;

FIG. 7 is a flow chart illustrating a fabricating process of a liquid crystal panel for liquid crystal display devices according to the present invention.

### DETAILED DESCRIPTION OF THE ILLUSTRATED EMBODIMENTS

Reference will now be made in detail to an embodiment of the present invention, which is illustrated in the accompanying drawings.

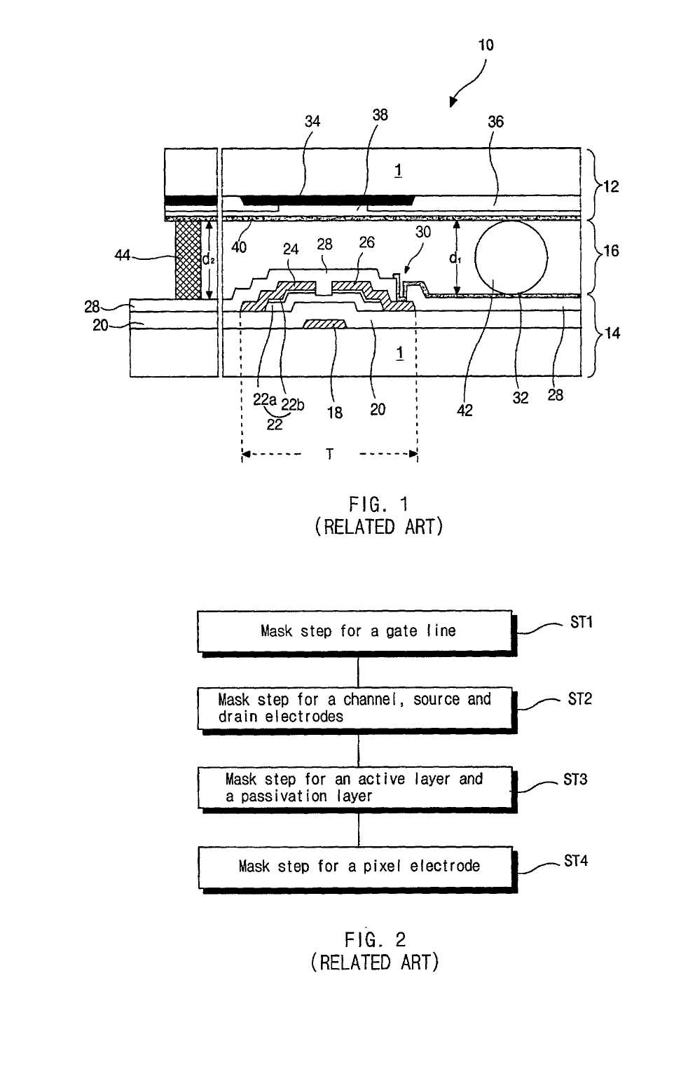

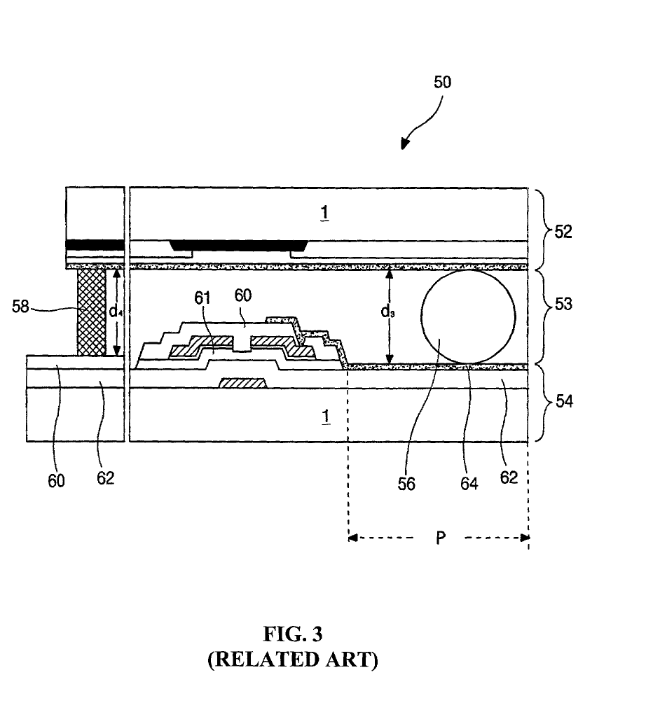

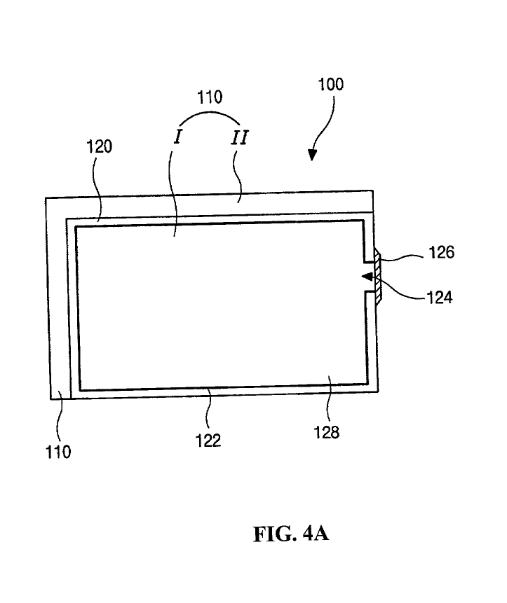

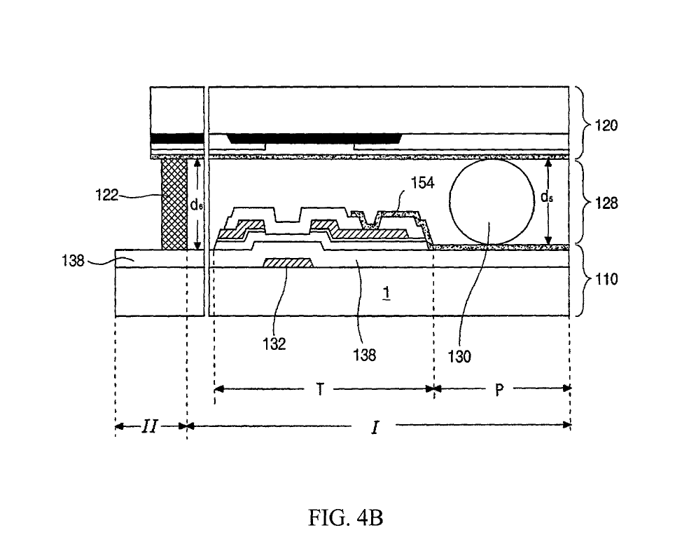

In FIG. 4A, a liquid crystal panel 100 includes a lower substrate 110, referred to as an array substrate, that has a display area I and a non-display area II, and an upper substrate 120, referred to as a color filter substrate, that has an area corresponding to the display area I. The upper substrate 120 and the lower substrate 110 are spaced apart and face each other. A seal pattern 122 is formed between the upper substrate 120 and the lower substrate 110 along a boundary region between the display area I and the non-display area II. The seal pattern 122 has an injection hole 124 and liquid crystal 128 is injected to a liquid crystal cell through the injection hole 124. A seal 126 is formed to seal the injection hole 124 and thus prevent the liquid crystal 128 from leaking out. The seal pattern 122 serves to make a cell gap for injecting the liquid crystal 128 and to bond the upper substrate 120 and the lower substrate 110. The seal pattern 122 is formed by a screen printing process using thermosetting resin that includes glass fiber. FIG. 4B is a cross-sectional view illustrating a part of a liquid crystal panel that includes an array substrate fabricated according to the present invention. As shown in the figure, the upper substrate 120 and the lower substrate 110 are spaced apart and face each other. The upper substrate 120 of FIG. 4 has substantially the same structure as the upper substrate 12 of FIG. 1. A gate electrode 132 is formed on a transparent substrate 1 of the lower substrate 110, and a gate insulating layer 138 is formed on an entire area of the lower substrate 110 and on the gate electrode 132. A thin film transistor “T” including the gate electrode 132 is formed on the gate insulating layer 138. A pixel electrode 154 is connected to the thin film transistor “T”. A seal pattern 122 is formed between the upper substrate 120 and the lower substrate 110 along a boundary between the display area I and the non-display area II. A spacer 130 is disposed in the display area to uniformly maintain a cell gap distance between the upper substrate 120 and the lower substrate 110. Because a pixel electrode 154 is very thin and thus does not affect the cell gap distance d₅ in the pixel region “P”, the cell gap distance d₅ in the pixel region and the cell gap distance d₆ in the seal pattern forming region can be uniformly maintained.

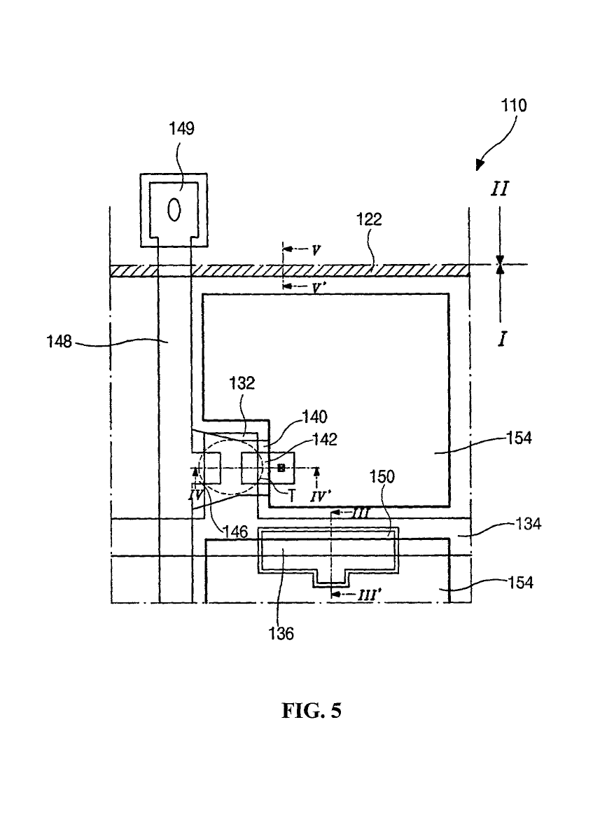

In FIG. 5, a horizontal gate line 134 that includes a gate electrode 132 and a capacitance electrode 136, is formed on the array substrate 110. A vertical data line 148 that includes a drain electrode 146 is formed on the array substrate 110 and the data line 148 crosses the gate line 134. A data pad 149 is formed at one end of the data line 148. A source electrode 142 is spaced apart from the drain electrode 146, and a pixel electrode 154 is connected to the source electrode 142 and partially overlapped with the capacitance electrode 136. A semi-conductor layer 140 is formed under the source and drain electrodes 142 and 146 and the thin film transistor “T” including the gate electrode 132. An auxiliary capacitance electrode 150 that is connected to the pixel electrode 154 is formed between the capacitance electrode 136 and the pixel electrode 154. The seal pattern 122 is formed between the data pad 149 and an adjacent portion of the data line 148 to assemble the upper substrate 120 and the lower substrate 110 with a uniform cell gap. The seal pattern 122 divides the array substrate 110 into the display area I and the non-display area II. The passivation layer is removed in a hatched area in the figure, where electric lines are not formed. The removal of the passivation layer maintains the cell gap distances between the display area I and the seal pattern forming region.

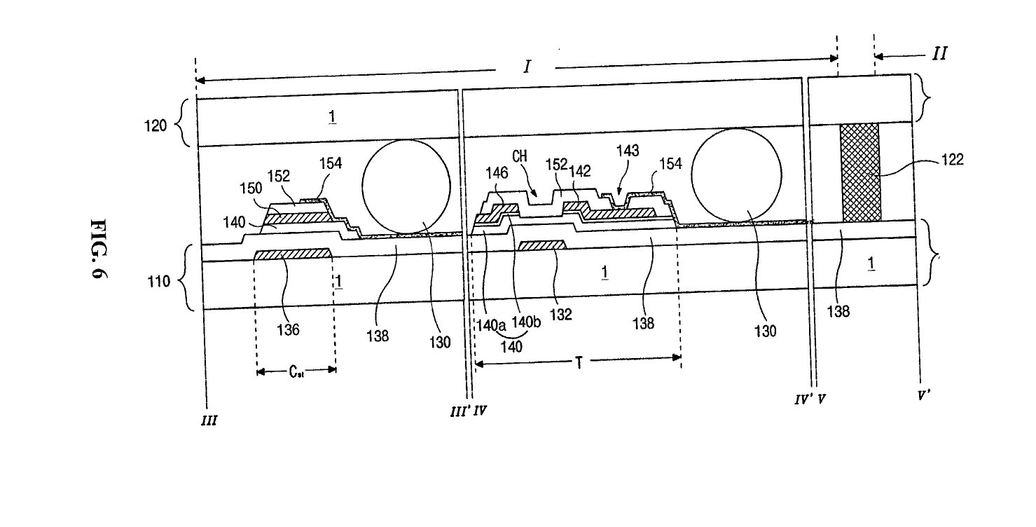

FIG. 6 is a view of a liquid crystal panel that includes the array substrate of FIG. 5 and illustrates cross-section taken along III-III′, IV-IV′ and V-V′ of FIG. 5. In a cross-sectional view taken along III-III′ of FIG. 5, the upper substrate 120 and the lower substrate 110 are spaced apart and face each other and the spacer 130 is disposed between the upper substrate 120 and the lower substrate 110 to uniformly maintain the cell gap. The lower substrate 110 in the cross-sectional view taken along III-III′ of FIG. 5 illustrates a storage capacitor region “Cₛₜ”. As shown in the figure, the capacitance electrode 136 is formed on the transparent substrate and the gate insulating layer 138 is formed on the substrate 1 and on capacitance electrode 136. The semi-conductor layer 140 is formed on the gate insulating layer 138 and the auxiliary capacitance electrode 150 is formed on the semi-conductor layer 140. A passivation layer 152 is formed on the auxiliary capacitance electrode 150 and the pixel electrode 154 is formed on the passivation layer 152. The pixel electrode 154 contacts a lateral side of the auxiliary capacitance electrode 150.

In a cross-sectional view taken along IV-IV′ of FIG. 5, the spacer 130 is disposed between the upper substrate 120 and the lower substrate 110. The lower substrate 110 in the cross-sectional view taken along IV-IV′ of FIG. 5 illustrates a thin film transistor region “T”. As shown in the figure, the gate electrode 132 is formed on the transparent substrate 1 and the gate insulating layer 138 is formed on the substrate 1 and on the gate electrode 132. The semi-conductor layer 140 that includes an active layer 140a and an ohmic contact layer 140b is formed on the gate insulating layer 138. The source electrode 142 and the drain electrode 146 that are spaced apart from each other are formed on the semi-conductor layer 140. The passivation layer 152 that has a source contact hole 143 is formed on the source and drain electrode 142 and 146. A pixel electrode 154 that is connected to the source electrode 142 through the source contact hole 143 is formed on the passivation layer 152. A channel “CH” is formed by exposing the active layer 140a between the source and drain electrode 142 and 146, and the passivation layer 152 protects the channel “CH” Because the passivation layer 152 and the active layer 140 are patterned simultaneously according to a four mask process for the array substrate 110, only the gate insulating layer 138 exists under the pixel electrode 154 that is connected to the storage capacitor “Cₛₜ” and the thin film transistor “T”. That is, as shown in the cross-sectional views taken along III-III′ and IV-IV′ of FIG. 5, the cell gap distance between the upper substrate 120 and the lower substrate 110 depends on steps of the lower substrate 110. Because the spacer 130 has a contraction ratio of about 10˜15%, the spacer 130 can maintain the cell gap uniformly even on a higher step of an array element by the contraction property of the spacer.

In cross-sectional view taken along V-V′ of FIG. 5, only the gate insulating layer 138 is formed on the transparent substrate 1 in the boundary region between the display area I and the non-display area II to maintain the cell gap distance uniformly. That is, because the pixel electrode 154 is formed very thin and thus does not affect a cell margin, the cell gap in the display area I and the cell gap in the boundary region between the display area I and the non-display area II can be uniformly maintained.

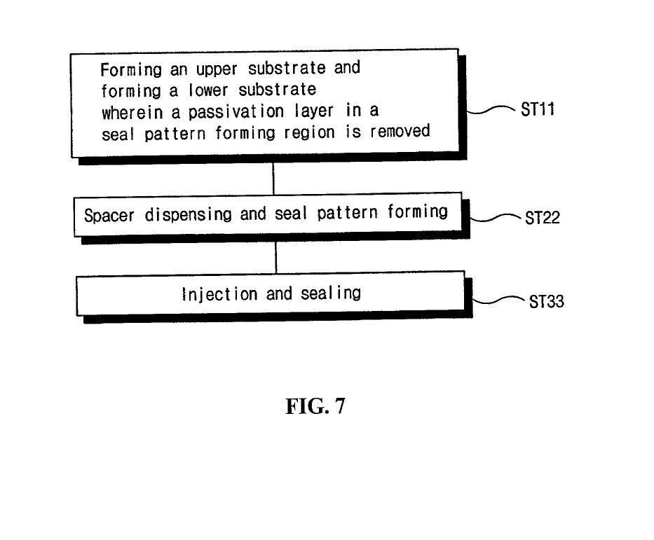

FIG. 7 is a flow chart illustrating a fabricating process of a liquid crystal panel for liquid crystal display devices according to the present invention. A first step ST11 includes preparing upper and lower substrates. The lower substrate includes a first substrate and is divided into the display area I and the non-display area II. The gate insulating layer is formed on the first substrate and the thin film transistor is formed on the gate insulating layer. The pixel electrode that is connected to the thin film transistor is formed on the gate insulating layer. The passivation layer is formed on the thin film transistor and the passivation layer on the seal pattern forming region is exposed to light to be etched away during a photolithographic masking process. Because the passivation layer on the seal pattern forming region is removed, the seal pattern can be formed directly on the gate insulating layer. The upper substrate has an area corresponding to the display area of the lower substrate and includes a second substrate, a color filter and a common electrode.

In a second step ST22, spacers are dispensed to the display area and the seal pattern that has an injection hole is formed. The spacer dispensing and the seal pattern forming processes may be performed on only one substrate or may be performed on the upper substrate and the lower substrate, respectively. Though not shown in the figure, an alignment layer coating process and a rubbing process precedes the spacer dispensing process and the seal pattern forming process. As described before, the seal pattern is formed on the seal pattern forming area, and the passivation layer has already been removed in the previous step to directly form the seal pattern on the gate insulating layer. Accordingly, the cell gap can be stabilized during a later assembling process of the upper and lower substrates.

A third step SS33 includes liquid crystal injection. The liquid crystal is injected into an interior of the seal pattern, i.e., a liquid crystal cell, and the injection hole of the seal pattern is sealed when the liquid crystal injection is completed. The liquid crystal panel that includes the array substrate fabricated using four mask process can be manufactured by introducing the techniques described herein.

It will be apparent to those skilled in the art that various modifications and variation can be made in the liquid crystal panel for liquid crystal display devices and the method of fabricating the liquid crystal panel of the present invention without departing from the spirit or scope of the invention. Thus, it is intended that the present invention cover the modifications and variations of this invention provided they come within the scope of the appended claims and their equivalents.

What is claimed is:

1. A liquid crystal panel for liquid crystal display devices comprising:
a lower substrate including a seal pattern forming region between a display area and a non-display area of the lower substrate, wherein a passivation layer is removed;
an upper substrate;
a seal pattern formed in a boundary region between the display area and the non-display area of the lower substrate; and
a liquid crystal layer between the upper substrate and the lower substrate.

2. The device according to claim 1, wherein the lower substrate further includes a first substrate, the display area and the non-display area.

3. The device according to claim 2, wherein the lower substrate further includes a gate electrode on the first substrate, a gate insulating layer on the first substrate and on the gate electrode, a thin film transistor on the gate insulating layer, a pixel electrode that is connected to the thin film transistor on the gate insulating layer and a passivation layer on the thin film transistor.

4. The device according to claim 1, wherein the upper substrate includes a second substrate, a color filter and a common electrode.

5. The device according to claim 1, wherein the passivation layer in the boundary region between the display area and the non-display area of the lower substrate is removed during a photolithographic mask step for simultaneous patterning an active layer and the passivation layer.

6. The device according to claim 1, wherein the liquid crystal panel of the present invention further comprises spacers between the upper substrate and the lower substrate.

7. A fabricating method for a liquid crystal panel for liquid crystal display devices comprising:
forming a lower substrate wherein a passivation layer in a boundary region between a display area and a non-display area of the lower substrate is removed;
forming an upper substrate including a second substrate, a color filter and a common electrode;
forming spacers in the display area between the upper substrate and the lower substrate;
forming a seal pattern in a boundary region between the display area and the non-display area of the lower substrate, the seal pattern contacting a gate insulating layer;
assembling the upper substrate and the lower substrate; and
injecting liquid crystal into an interior of the seal pattern.

8. The method according to claim 7, wherein the forming the lower substrate further comprises:
forming a gate electrode on a first substrate;
forming a gate insulating layer on the first substrate and on the gate electrode;
forming a thin film transistor on the gate insulating layer; and
forming a pixel electrode on the gate insulating layer, the pixel electrode being connected to the thin film transistor.

9. A liquid crystal panel for liquid crystal display devices comprising:
a lower substrate including a first substrate;
a gate electrode on the first substrate;
a gate insulating layer on the first substrate and on the gate electrode;
a thin film transistor on the gate insulating layer;
a pixel electrode on the gate insulating layer, the pixel electrode being connected to the thin film transistor;
a passivation layer on the thin film transistor, the lower substrate being divided into a display area and a non-display area and further including a seal pattern forming region between the display area and the non-display area of the lower substrate, wherein a passivation layer is removed;
an upper substrate including a second substrate, a color filter and a common electrode; a seal pattern formed in a boundary region between the display area and the non-display area of the lower substrate; and
a liquid crystal layer between the upper substrate and the lower substrate.

10. A liquid crystal panel comprising:
a lower substrate having a display area and a non-display area;
an upper substrate having an area corresponding to the display area, the upper substrate and the lower substrate spaced apart and facing each other;
a seal pattern formed between the upper substrate and the lower substrate along a boundary region between the display area and the non-display area, the seal pattern having an injection hole; and
liquid crystal injected to a liquid crystal cell through the injection hole, wherein a seal is formed to seal the injection hole, the seal pattern serving to make a cell gap for injecting the liquid crystal and to bond the upper substrate and the lower substrate.

11. The liquid crystal panel of claim 10, wherein the seal pattern is formed by a screen printing process using thermosetting resin that includes glass fiber.

12. A liquid crystal panel comprising:
an upper substrate and a lower substrate spaced apart and facing each other;
a gate electrode formed on a transparent substrate of the lower substrate, and a gate insulating layer formed on an entire area of the lower substrate and on the gate electrode;
a thin film transistor including the gate electrode formed on the gate insulating layer;
a pixel electrode connected to the thin film transistor;
a seal pattern formed between the upper substrate and the lower substrate along a boundary between a display area and a non-display area; and
a spacer disposed in the display area to uniformly maintain a cell gap distance between the upper substrate and the lower substrate.

13. A liquid crystal panel comprising:
a horizontal gate line that includes a gate electrode and a capacitance electrode formed on an array substrate;
a vertical data line that includes a drain electrode and formed on the array substrate, the data line crossing the gate line;
a data pad formed at one end of the data line;
a source electrode spaced apart from the drain electrode, and a pixel electrode connected to the source electrode and partially overlapped with the capacitance electrode;
a semi-conductor layer formed under the source and drain electrodes and the thin film transistor including the gate electrode;
an auxiliary capacitance electrode connected to the pixel electrode and formed between the capacitance electrode and the pixel electrode;
a seal pattern formed between the data pad and an adjacent portion of the data line to assemble the upper substrate and the lower substrate with a uniform cell gap, the seal pattern dividing the array substrate into a display area and a non-display area;
a passivation layer removed where electric lines are not formed, the removal of the passivation layer maintaining cell gap distances between the display area and the seal pattern forming region.

14. A liquid crystal panel comprising:
an upper substrate and a lower substrate spaced apart and facing each other;
a spacer disposed between the upper substrate and the lower substrate to uniformly maintain a cell gap;
a storage capacitor region including a capacitance electrode formed on a transparent substrate;
a gate insulating layer formed on the transparent substrate and on the capacitance electrode;
a semi-conductor layer formed on the gate insulating layer and an auxiliary capacitance electrode formed on the semi-conductor layer;
a passivation layer formed on the auxiliary capacitance electrode and a pixel electrode formed on the passivation layer, the pixel electrode contacting a lateral side of the auxiliary capacitance electrode.

15. The liquid crystal panel according to claim 14, further comprising a thin film transistor region including:
a gate electrode formed on the transparent substrate, and the gate insulating layer formed on the transparent substrate and on the gate electrode;
a source electrode and a drain electrode spaced apart from each other and formed on the semi-conductor layer.

16. The liquid crystal panel according to claim 14, wherein the semi-conductor layer includes an active layer and an ohmic contact layer, the semi-conductor layer being formed on the gate insulating layer.

17. The liquid crystal panel according to claim 14, wherein only the gate insulating layer is formed on the transparent substrate in the boundary region between the display area and the non-display area to maintain the cell gap distance uniformly.

18. A fabricating process of a liquid crystal panel for liquid crystal display devices comprising:
a first step including:
preparing upper and lower substrates, the lower substrate including a first substrate divided into a display area and a non-display area, a gate insulating layer formed on the first substrate and a thin film transistor formed on the gate insulating layer, a pixel electrode connected to the thin film transistor and formed on the gate insulating layer, a passivation layer formed on the thin film transistor, the passivation layer on a seal pattern forming region and being exposed to light to be etched away during a photolithographic masking process, the seal pattern formed directly on the gate insulating layer, the upper substrate having an area corresponding to the display area of the lower substrate, the upper substrate including a second substrate, a color filter and a common electrode;
a second step including:
providing spacers dispensed on the display area; and
forming a seal pattern having an injection hole,
wherein the spacer dispensing and the seal pattern forming processes are performed on one of only one substrate or on both the upper substrate and the lower substrate, respectively;
a third step including:
injecting a liquid crystal into an interior of the seal pattern; and
sealing the injection hole of the seal pattern.

19. The fabricating process of a liquid crystal panel according to claim 23, wherein an alignment layer coating process and a rubbing process precedes the spacer dispensing process and the seal pattern forming process.

20. The fabricating process of a liquid crystal panel according to claim 23, wherein the passivation layer and the active layer are patterned simultaneously according to a four mask process and only the gate insulating layer exists under the pixel electrode that is connected to the storage capacitor and the thin film transistor.
